(19) United States
(12) Patent Application Publication
(10) Pub. No.: US 2026/0034899 A1
(43) Pub. Date: Feb. 5, 2026

(54) SYSTEMS AND METHODS TO POWER ELECTRIC VEHICLES AND INFRASTRUCTURE

(71) Applicant: Saudi Arabian Oil Company, Dhahran (SA)

(72) Inventors: Aqil Jamal, Dhahran (SA); Alexey Izgorodin, Dhahran (SA); Abdulrahman S. Alsuhaibani, Dammam (SA)

(21) Appl. No.: 18/794,575

(22) Filed: Aug. 5, 2024

(51) Int. Cl. B60L 50/75; B60L 50/72; B60L 58/40

(52) U.S. Cl. CPC B60L 50/75; B60L 50/72; B60L 58/40

(57) ABSTRACT

Techniques for supplying power to an electrical load include electrically coupling a power supply system to an electrical load. The power supply system includes a chemical energy sub-system including a fuel cell and a fuel storage assembly that stores a fuel, where the fuel cell is configured to generate a first electrical energy output at a first power output; an electrochemical energy sub-system including an energy storage device configured to generate a second electrical energy output at a second power output; and a power control unit electrically coupled to the chemical energy sub-system and the electrochemical energy sub-system and electrically coupled to the electrical load. The method includes operating the power control unit to provide the first electrical energy output or the second electrical energy output to the electrical load.

### TECHNICAL FIELD

This disclosure relates to systems and methods to power electric vehicles or other infrastructure (or both) and, more particularly, systems and methods to power electric vehicles or other infrastructure (or both) with a chemical-based energy subsystem (CES) in combination with an electrochemical energy subsystem (EES).

### BACKGROUND

In order to reduce emissions related to transportation, electric mobility is taking on an increasingly important role. In particular, battery electric vehicles (BEV) provide a technologically-ready solution, but their adoption is hindered by the high costs of charging infrastructure, long charging times, and the high cost of the battery pack necessary to ensure adequate driving range. Fuel cell vehicles (FCEV) can have faster refueling times and a lower cost of energy storage, thereby enabling a driving range comparable with traditional vehicles. However, FCEV adoption is hindered by the high cost of high-pressure refueling infrastructure and fuel cells.

### SUMMARY

In an example implementation, a power supply system includes a chemical energy sub-system including at least one fuel cell and at least one fuel storage assembly. The at least one fuel cell is configured to generate a first electrical energy output at a first power output from a fuel stored in the at least one fuel storage assembly. The system includes an electrochemical energy sub-system including at least one energy storage device. The at least one energy storage device is configured to generate a second electrical energy output at a second power output. The system includes a power control unit electrically coupled to the chemical energy sub-system and the electrochemical energy sub-system and configured to electrically couple the chemical energy sub-system and the electrochemical energy sub-system to an electrical load and provide at least one of the first electrical energy output or the second electrical energy output to the electrical load. The electrical load has a first power demand over a first time duration that is less than the first power output and a second power demand over a second time duration that is less than the second power output, the second time duration less than the first time duration.

In an aspect combinable with the example implementation, the chemical energy sub-system includes a thermal conductive medium thermally coupled between the at least one fuel cell and the fuel storage assembly.

In another aspect combinable with one, some, or all of the previous aspects, the thermal conductive medium includes a fluid heat transfer medium or a solid heat transfer medium.

In another aspect combinable with one, some, or all of the previous aspects, the fuel storage assembly includes a metal hydride, and the thermal conductive medium is thermally coupled between the at least one fuel cell and the metal hydride.

In another aspect combinable with one, some, or all of the previous aspects, the fuel includes uncompressed hydrogen, and the metal hydride is configured to exothermically adsorb at least a portion of the uncompressed hydrogen.

In another aspect combinable with one, some, or all of the previous aspects, the metal hydride includes iron titanium (FeTi) or magnesium (Mg).

In another aspect combinable with one, some, or all of the previous aspects, the at least one energy storage device includes a multi-gradient electrode.

In another aspect combinable with one, some, or all of the previous aspects, the multi-gradient electrode includes a multi-gradient graphite anode or a lithium metal anode.

In another aspect combinable with one, some, or all of the previous aspects, the at least one energy storage device includes a nano-crystallized Lithium cathode and a superconducting electrolyte.

In another aspect combinable with one, some, or all of the previous aspects, the electrochemical energy sub-system is configured to electrically couple to the electrical load through the power control unit to provide the second electrical energy output to the electrical load and charge the at least one energy storage device with an electrical charging output from the electrical load through the power control unit.

In another aspect combinable with one, some, or all of the previous aspects, each of the first power output energy storage capacity is between 100-200 kWh and second power output energy storage capacity is between 5-10 kWh.

In another aspect combinable with one, some, or all of the previous aspects, the chemical energy sub-system is configured to provide a first power capacity of 5-20 kW over the first time duration.

In another aspect combinable with one, some, or all of the previous aspects, the electrochemical energy sub-system is configured to have a second power capacity of 100-200 kW over the second time duration.

In another aspect combinable with one, some, or all of the previous aspects, the first time duration is 5-40 hours, and the second time duration is 1.5-10 minutes.

In another aspect combinable with one, some, or all of the previous aspects, the electrical load includes a mobile electrical load.

In another aspect combinable with one, some, or all of the previous aspects, the mobile electrical load includes an electric vehicle for fuel cell vehicle.

In another aspect combinable with one, some, or all of the previous aspects, the chemical energy subsystem includes an electrochemical device for hybrid electrical energy storage and hydrogen production.

In another example implementation, a method of supplying power to an electrical load includes electrically coupling a power supply system to an electrical load. The power supply system includes a chemical energy sub-system including at least one fuel cell and at least one fuel storage assembly that stores a fuel, where the at least one fuel cell configured to generate a first electrical energy output at a first power output from the fuel; an electrochemical energy sub-system including at least one energy storage device configured to generate a second electrical energy output at a second power output; and a power control unit electrically coupled to the chemical energy sub-system and the electrochemical energy sub-system and electrically coupled to the electrical load. The method includes operating the power control unit to provide at least one of the first electrical energy output or the second electrical energy output to the electrical load, the electrical load having a first power demand over a first time duration that is less than the first power output and a second power demand over a second time duration that is less than the second power output. The second time duration is less than the first time duration.

An aspect combinable with the example implementation includes transferring thermal energy between the at least one fuel cell and the fuel storage assembly with a thermal conductive medium.

In another aspect combinable with one, some, or all of the previous aspects, the thermal conductive medium includes a fluid heat transfer medium or a solid heat transfer medium.

In another aspect combinable with one, some, or all of the previous aspects, transferring thermal energy includes transferring thermal energy between a metal hydride of the fuel storage assembly and the at least one fuel cell with the thermal conductive medium.

In another aspect combinable with one, some, or all of the previous aspects, the fuel includes uncompressed hydrogen, and the method includes exothermically adsorb at least a portion of the uncompressed hydrogen into the metal hydride.

In another aspect combinable with one, some, or all of the previous aspects, the metal hydride includes iron titanium (FeTi) or magnesium (Mg).

Another aspect combinable with one, some, or all of the previous aspects includes storing the second electrical energy output in the at least one energy storage device with a multi-gradient electrode.

In another aspect combinable with one, some, or all of the previous aspects, the multi-gradient electrode includes a multi-gradient graphite anode or a lithium metal anode.

In another aspect combinable with one, some, or all of the previous aspects, the at least one energy storage device includes a nano-crystallized Lithium cathode and a superconducting electrolyte.

Another aspect combinable with one, some, or all of the previous aspects includes charging the at least one energy storage device with an electrical charging output from the electrical load through the power control unit.

In another aspect combinable with one, some, or all of the previous aspects, each of the first power output energy storage capacity is between 100-200 kWh and second power output energy storage capacity is between 5-10 kWh.

In another aspect combinable with one, some, or all of the previous aspects, the chemical energy sub-system is configured to provide a first power capacity of 5-20 kW over the first time duration, and the electrochemical energy sub-system is configured to have a second power capacity of 100-200 kW over the second time duration.

In another aspect combinable with one, some, or all of the previous aspects, the first time duration is 5-40 hours, and the second time duration is 1.5-10 minutes.

In another aspect combinable with one, some, or all of the previous aspects, the electrical load includes a mobile electrical load.

In another aspect combinable with one, some, or all of the previous aspects, the mobile electrical load includes an electric vehicle for fuel cell vehicle.

In another aspect combinable with one, some, or all of the previous aspects, the chemical energy subsystem includes an electrochemical device for hybrid electrical energy storage and hydrogen production.

Implementations of power supply systems and methods according to the present disclosure may include one or more of the following features. For example, implementations according to the present disclosure can reduce a cost of hydrogen powered electric vehicles compared to traditional FCEV and BEV while substantially increasing vehicle driving range. As another example, implementations according to the present disclosure can enable the use of low-cost refueling infrastructure, including optional home refueling due to the use of low pressure hydrogen. Further, implementations according to the present disclosure can enable relatively high round trip energy efficiency and integration of renewable energy resources.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example implementation of a power supply system according to the present disclosure.

FIG. 2 is a schematic diagram of another example implementation of a power supply system according to the present disclosure.

FIG. 3 is a schematic illustration of an example controller (or control system) for a power supply system according to the present disclosure.

### DETAILED DESCRIPTION

The present disclosure describes example implementations of a power supply system operable to power vehicles, stationary infrastructure, or both according to the present disclosure. In example implementations, a power supply system according to the present disclosure operates to power mobile (for example, electric vehicles) structures as well as and stationary applications by combining a low cost, long duration, chemical-based energy subsystem (CES) with a short duration, high power, multidirectional electrochemical energy subsystem (EES). Example implementations according to the present disclosure can reduce (for example, significantly) an overall cost of a power supply system, provide high power and storage capacity, reduce a cost of refueling infrastructure for mobility applications and increase safety.

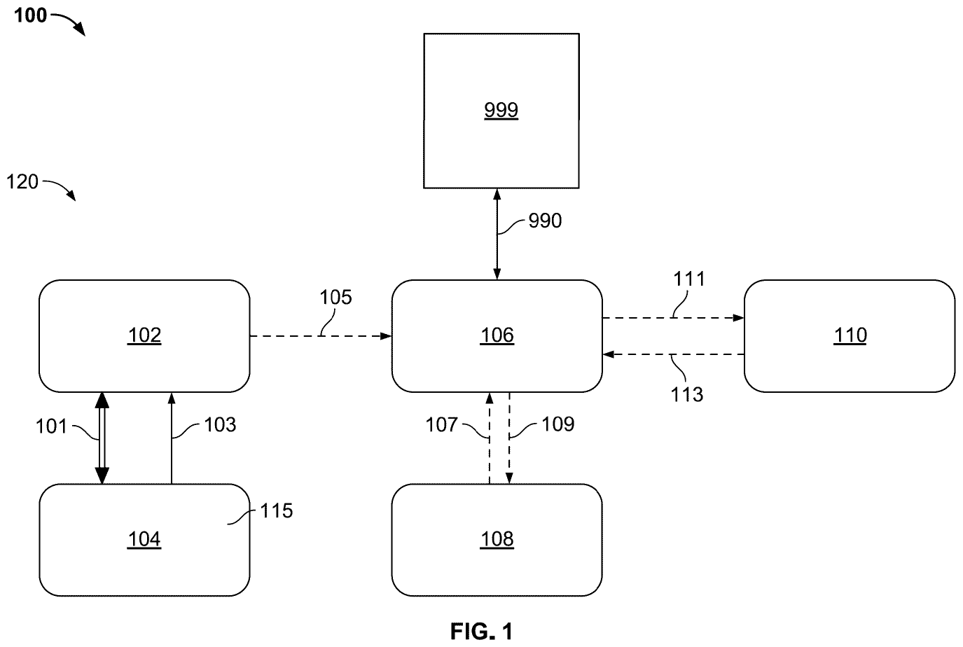

FIG. 1 is a schematic diagram of an example implementation of a power supply system 100 according to the present disclosure. In the illustrated implementation, the power supply system 100 includes a chemical-based energy subsystem (CES) 102 and an electrochemical energy subsystem (EES) 108, each of which is electrically coupled (indirectly, as shown in this example) to an electrical load 110. The electrical load 110, for example, can be a mobile electrical load, such as an EV, a stationary electrical load, such as a building or infrastructure, or a combination of both.

In this example implementation, the CES 120 includes a fuel cell 102 that is coupled by a fuel conduit 103 and a thermal conductive medium 101 to a fuel storage assembly 104. In example implementations, a fuel 115 (stored in the fuel storage assembly 104) can be hydrogen such that the fuel storage assembly 104 supplies hydrogen to the fuel cell 102 through fuel conduit 103. In some aspects, the fuel storage assembly 104 is sized to store a sufficient volume of the fuel 115 in order to operate the fuel cell 102 to generate electrical energy 105 at a particular power output to operate the electrical load 110 for a particular time duration (in other words, without re-filling the assembly 104 with additional fuel 115).

The thermal conductive medium 101, in this example with hydrogen, can be a fluid (liquid, gas, mixed-phase fluid) that transfers heat generated by operation of the fuel cell 102 to the fuel storage assembly 104. In some aspects, however, thermal conductive medium 101 can comprise a solid metal in a form of plates or bars made of, for example, copper or aluminum. As another example, the thermal conductive medium 101 can be liquids such as water, glycerol, ethylene glycol, propylene glycol, silicon oil circulated through conduits. The thermal conductive medium 101 can also be a gaseous refrigerant such as hydrofluorocarbons, halogenated fluorocarbons, halogenated fluorine olefins, natural refrigerants (for example, carbon dioxide, ammonia, propane, hydrogen).

Generally, the CES 120 that includes fuel cell 102 is operable to generate electricity from the fuel (hydrogen gas) and air or oxygen. Pressurized hydrogen gas is stored in the fuel storage assembly 104 (or tank 104) that, in some aspects, includes or is formed of a metal hydride.

In operation, the CES 120 generates electrical energy 105 (for example, current at a particular voltage carried through a conduit) at a minimum power required for a total amount of energy produced by the CES 120 over designated and relatively (compared to the EES 108) long-term period to exceed a total amount of energy consumed by the electrical load 110 over the same time period. In some aspects, the designated long term time period can be determined by electrical load variability. Thus, the subsystem energy storage capacity of the CES 120 can be designed to exceed a total electrical energy required by the electrical load 110 prior to needing refueling of the fuel storage assembly 104.

In some aspects, as illustrated, the fuel cell 102 produces the electrical energy 105 from the hydrogen gas (as fuel) and air (as oxidant). The thermal conductive medium 101 exchanges heat between the fuel cell 102 and the fuel storage assembly 104 (as metal hydride). Although not specifically illustrated in FIG. 1, the CES 120 can use heat exchanger(s) and pump(s) for the circulation of a fluid through which the heat exchange occurs. For example, in example implementations, the CES 120 can include a single tank containing metal hydrides in thermal contact with the fuel cell 102, which can improve both absorption and desorption stages of hydrogen from metal hydrides and the control of a temperature of the fuel cell 102.

In example implementations, a metal hydride of the fuel storage assembly 104 can store fuel (such as hydrogen) without a need for compression. For instance, when hydrogen fuel interacts with metal hydride(s), the hydrogen fuel can be chemically bonded or absorbed by the metal hydride(s). The adsorption of hydrogen is an exothermic process while desorption is an endothermic process. Thus, the fuel storage assembly 104 that contains metal hydrides increases in temperature when it adsorbs hydrogen, while the temperature decreases if it desorbs hydrogen. The stored hydrogen can be discharged through various methods including, for example, direct heating. Examples of the metal hydrides include magnesium and iron titanium.

In example implementations, a metal hydride can absorb and regenerate hydrogen in a temperature range between 10-250° C.; alternatively, the range can be between 10-120° C.; alternatively, the range can be between 10-80° C. In example implementations, the metal hydride can be comprised of iron titanium (FeTi); alternatively, the metal hydride can be comprised of magnesium (Mg) (as examples). In example implementations, low purity hydrogen gas generated from fossil fuels can be used to recharge metal hydride that is resistant to impurities in such hydrogen gas. In such examples, metal hydride can preferentially capture hydrogen gas during a capture cycle and subsequently releases high purity hydrogen gas during a release cycle.

Unlike compressed gas or liquid hydrogen storage, metal hydrides of the fuel storage assembly 104 can offer inherent safety advantages and can achieve higher volume densities for hydrogen storage. The present disclosure, however, also contemplates that the fuel storage assembly 104 stores a liquid, pressurized fuel (such as liquid hydrogen) in a tank that does not include metal hydrides.

As illustrated, the EES 108 is electrically coupled to the electrical load 110 (indirectly, for instance) in this example, to provide electrical energy 107 (through a conduit) to the electrical load 110. For example, the EES 108 can provide a fast rate (relative to the CES 120) of electrical charge and discharge. In some aspects, the EES 108 can include one or more batteries, such as, for example, lithium batteries. One of the limiting factors for fast charging of lithium batteries (for example, above 2C rates such as a full charge within 30 minutes) resides in the graphite electrode. In such cases, there can be a risk of lithium plating/deposition in a metallic form on the graphite. This can lead to the formation of dendrites, potential electrolyte reactions, and subsequent loss of lithium, thereby accelerating cycle life deterioration. Additionally, the graphite electrode may not achieve full lithiation due to elevated cell polarization, causing it to reach cut-off voltage prematurely and thus reducing usable capacity.

In example implementations, the EES 108 can include a multi-gradient graphite electrode. This electrode can comprise two or more layers of graphite, with each layer possessing a different level of porosity as compared to other layers. The layers with higher porosity are positioned closer to the electrode's surface, enabling lithium ions to travel swiftly. Such design impedes lithium plating during the charging process. Consequently, lithium ions can penetrate the inner regions and achieve full lithiation, thus mitigating the risk of lithium plating and dendrite formation.

In example implementations, the EES 108 can include nano crystallized lithium iron phosphate cathode materials that can accelerate extraction of lithium ions. Alternatively, the EES 108 can include a superconducting electrolyte to decrease resistance of lithium-ion movement.

As shown in FIG. 1, the electrical energy 105 and the electrical energy 107 are provided to the electrical load 110, through a power control unit 106, as electrical energy 111. The power control unit 106, in some aspects, can include switch gear, inverters, transformers, and other electrical equipment (as necessary) to transfer energy with the electrical load 110 through electrical conduit 113, 111 (for a bidirectional flow of energy between the electrical load 110 and the EES 108) and with EES 108 through electrical conduit 109, 107. In addition, electrical energy can be transferred from fuel cell 102 to the power control unit 106 through an electrical conduit 105.

In example operations, the power control unit 106 can perform (alone or in combination a control system 999 described herein) algorithmic operations to control the output of the electrical energy 111 to the electrical load 110. For example, the power control unit 106 can adjust a power output of the CES 120 within 0-200% of a nominal power capacity of the CES 120. For instance, operating the CES 120 at higher power output than nominal can be unfavorable as it may result in a lower fuel-to-electricity conversion efficiency. During example operations, a power output of the CES 120 can be kept largely unchanged and is gradually adjusted based on the average state of charge in the EES 108. For example, power output from the CES 120 can be progressively increased as average (for example, over 1-5 minutes) state of charge of the EES 108 is reduced from 55 to 20% and progressively decreased as average (for example, over 1-5 min) state of charge of the EES 108 is increased from 55-90%.

In some aspects, a short-term energy demand by the electrical load 110 (for example, during car acceleration in the case of a mobile electrical load) is complimented by the EES 108, while a short-term energy supply from the electrical load 110 (for example, during car breaking) is absorbed by the EES 108. If a state of charge of the EES 108 falls below a certain threshold (for example, 30%) and the CES 120 operates at a maximum power output (for example, 200%), then the power control unit 106 can progressively curtail power output to the electrical load 110.

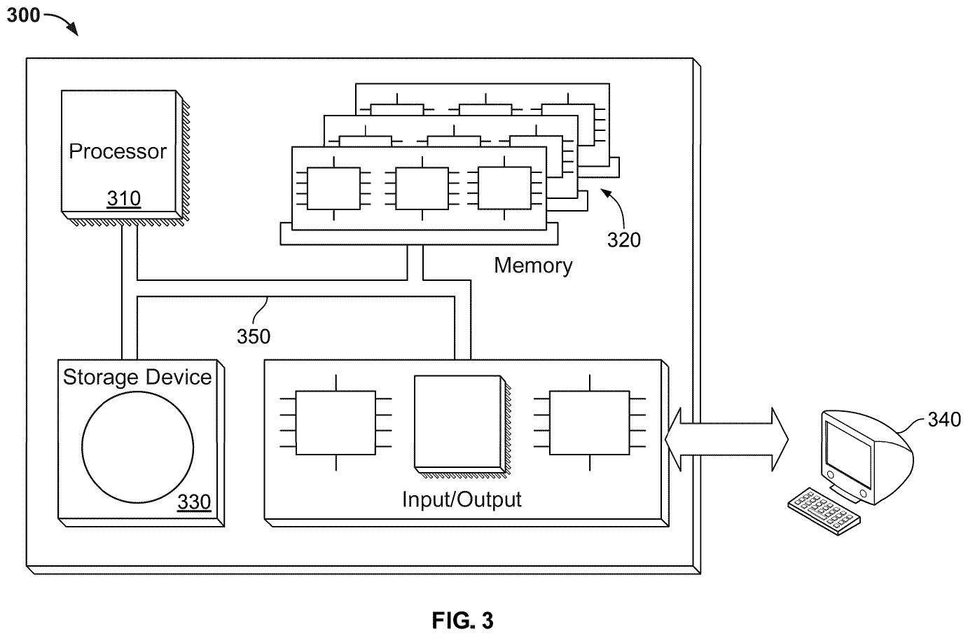

As shown in FIG. 1, a control system (or flow control system) 999 is communicably coupled within the power supply system 100, such as to the power control unit 106, to facilitate the exchange of commands and data 990 (collectively) within the system 100. For example, in FIG. 1, the process streams of the present disclosure can be flowed using one or more flow control systems 999 (also included in the example implementation of FIG. 3) implemented throughout the illustrated charging systems shown in the present disclosure. A flow control system 999 can include one or more flow pumps to pump the fluid streams (such as fuel 103), one or more flow pipes (as shown) through which the fluid streams are flowed and one or more valves to regulate the flow of streams through the pipes. In the present disclosure, a “pump” or “flow pump” can refer to a liquid pump that forcibly circulates a liquid or mixed phase fluid, a fan that circulates a gas, a compressor that compresses and circulates a fluid, or a turbine that expands and circulates a fluid.

Control system 999 can include one or more monitoring devices. In example implementations, control system 999 can include one or more pressure monitoring devices, temperature monitoring devices, and/or electrical monitoring devices shown in FIGS. 1 and 3.

In example implementations, flow control system 999 can be operated manually. For example, an operator can set a flow rate for each pump and set valve open or close positions to regulate the flow of the process streams through the pipes in flow control system 999. Once the operator has set the flow rates and the valve open or close positions for all flow control systems 999 distributed across the illustrated processes, flow control system 999 can flow the streams under constant flow conditions, for example, constant volumetric rate or other flow conditions. To change the flow conditions, the operator can manually operate control system 999, for example, by changing the pump flow rate or the valve open or close position.

In example implementations, flow control system 999 can be operated automatically. For example, the flow control system 999 can be connected to a computer or a computer-readable medium storing instructions (such as flow control instructions and other instructions) executable by one or more processors to perform operations (such as flow control operations). An operator can set the flow rates and the valve open or close positions for all flow control systems 999 distributed across the illustrated processes using the flow control system 999. In such implementations, the operator can manually change the flow conditions by providing inputs through the flow control system 999. Also, in such implementations, the flow control system 999 can automatically (that is, without manual intervention) control one or more of the flow control systems, for example, using feedback systems connected to flow control system 999. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to flow control system 999. In response to the flow condition exceeding a threshold (such as a threshold pressure value, a threshold temperature value, or other threshold value), control system 999 can automatically perform operations. For example, if the pressure or temperature in the pipe exceeds the threshold pressure value or the threshold temperature value, respectively, flow control system 999 can provide a signal to the pump to decrease a flow rate, a signal to open a valve to relieve the pressure, a signal to shut down process stream flow, or other signals.

In operation, the power supply system 100 can provide electrical energy 111 at specific voltage/current as determined by the electrical load requirements. Typical power capacity available from the EES 108 (such as for mobile applications like EVs) can be 100-200 kW, with energy storage capacity of 5-10 kWh, and a short duration period between 1.5-10 minutes. Typical power capacity available from the CES 120 (such as for mobile applications) can be 5-20 kW, with energy storage capacity of 100-200 kWh and a long duration period between 5 and 40 hours. The short-term energy demand by the electrical load 110 (for example, during car acceleration) is complimented by the EES 108, while short-term energy supply from the electrical load 110 (for example, during car breaking) is absorbed by the EES 108. If the EES state of charge falls below a certain threshold (for example, 30%) and the CES 120 operates at maximum power output (for example, 200%), the power supply unit 106 can progressively curtail power output to the electrical load 110.

Additionally, the CES 120 (generally) provides a steady state power to the electrical load 110, while the EES 108 is designed to supplement and absorb high power capacity bidirectional fluctuations of load demand. The steady state power output of the CES 120 can be gradually adjusted (by power control unit 106) based on the state of charge of the EES 108. In an unlikely event that the CES 120 operates at a maximum power capacity and the EES state of charge falls below a certain limit, the overall power output to the electrical load 110 can be curtailed by the power control unit 106.

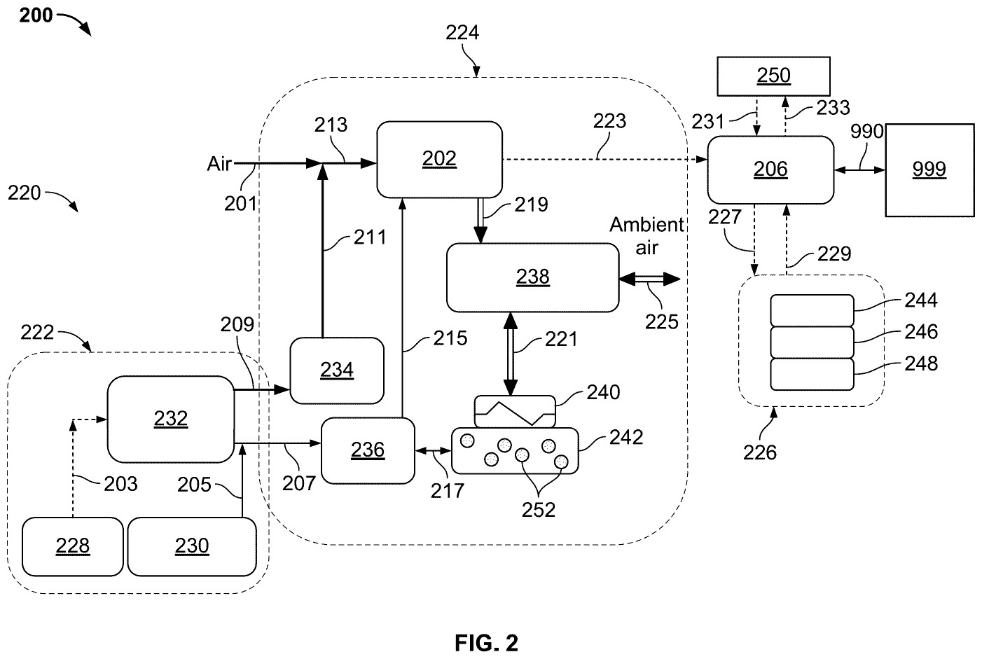

FIG. 2 is a schematic diagram of another example implementation of a power supply system 200 according to the present disclosure. In some aspects, the power supply system 200 is similar to the power supply system 100 shown in FIG. 1 but shown in more detail in FIG. 2. For example, the power supply system 200 includes a CES 220, an EES 226, and a power control unit 206 electrically coupled to an electrical load 250 (mobile, stationary, or both). In this example, generally, the CES 220 operates to provide electrical energy 223 to the power control unit 206, and the EES 226 operates to provide electrical energy 229 to the power control unit 206. The power control unit 206 operates, based on the electrical load requirements, to supply electrical energy 233 to the electrical load 250, while passing electrical charge to the EES 226 as electrical energy 227 (such as during mobile load braking).

In the example implementation of FIG. 2, the CES 220 can operate with sufficient energy storage capacity to meet an overall load demand (for example, 100-200 kWh) with a minimum power capacity to meet long duration load demand of between, for example, 5-20 kW. The EES 226 can operate with a minimum energy storage capacity to meet a short duration load demand of between, for example, 5-10 kWh with sufficient power capacity to meet an overall load demand (for example, 100-200 kW).

In this example implementation, the CES 220 includes a stationary sub-assembly 222 and a mobile sub-assembly 224. The stationary sub-assembly 222, in this example, includes a permanent or semi-permanent power source 228 (such as a grid, renewable source, nuclear, or otherwise) that is electrically coupled to a hybrid electrical energy storage device 232 to provide the means of reversibly storing electrical energy 203 using redox reactive material and hydrogen gas. The stationary sub-assembly 222 also includes (optionally) a compressed hydrogen gas source 230 that supplies compressed hydrogen gas 205 in combination with an output 207 from the hybrid electrical energy storage device 232 to the mobile sub-assembly 224 as shown. Further, the hybrid electrical energy storage device 232 can supply oxygen 209 to the mobile sub-assembly 224 as shown.

For example, as described in U.S. application Ser. No. 18/639,338 (incorporated by reference herein) a hybrid electrical energy storage device can reversibly store electrical energy using redox reactive material and hydrogen. The hybrid electrical energy storage device has low maintenance and very high round trip energy storage efficiency using pressurized hydrogen gas in include pressurized oxygen gas. In some aspects, the hybrid electrical energy storage device 232 enables refueling of a mobile power supply system using stored pressurized hydrogen gas or can refuel mobile sub-assembly 224 without transport of hydrogen gas. An optional compressed hydrogen gas source 230 can be provided in areas where a large vehicle fleet allows for economical hydrogen delivery (for example, in bus terminals, large car parks, or otherwise).

As shown in this example, the mobile sub-assembly 224 includes a hydrogen gas system 236, an oxygen storage system 234, a fuel cell 202, a thermal management system 238, and a pressure vessel 242 that includes or is formed of metal hydride 252. Although singular components are shown, one or more of the described components can be used in the power supply system 200. In operation, air 201 and, optionally, oxygen 211 is flowed to the fuel cell 202, as is a flow of hydrogen gas 215 from the hydrogen gas system 236. A flow of hydrogen gas 217 goes between the hydrogen gas system 236 and the pressure vessel 242. Thermal energy flows bidirectionally between the heat management system 238 and a heat exchanger 240 thermally coupled to the pressure vessel 242. Generally, the heat management system 238 includes one or more heat exchangers, circulation pumps, and heat pumps, and uses ambient air 225 (as well as exhausts ambient air). In operation, the fuel cell 202 produces the electrical energy 223 from the hydrogen gas 215 (as fuel) and air 213 (as oxidant). Thermal energy 219 output from operation of the fuel cell 202 is transferred to the heat management system 238.

In this example implementation, the EES 226 includes a nano-crystallized Lithium cathode 244 to reduce structural instability (for example, Lithium iron phosphate, Lithium Sulfur). The EES 226 also includes a multigradient graphite anode 246 (or, optionally, a lithium metal anode). The EES 226 also includes a superconducting electrolyte 248, such as a liquid, solid or polymer.

As with the power supply system 100, system 200 includes a flow control system 999 that is communicably coupled to the power control unit 206 to exchange commands and data 990 (collectively). In some aspects, the flow control system 999 can be part of the power control unit 206.

In operation, the power supply system 200 can provide electrical energy 233 at specific voltage/current as determined by the electrical load requirements of electrical load 250. Typical power capacity available from the EES 226 (such as for mobile applications like EVs) can be 100-200 kW, with energy storage capacity of 5-10 kWh, and a short duration period between 1.5-10 minutes. Typical power capacity available from the CES 220 (such as for mobile applications) can be 5-20 KW, with energy storage capacity of 100-200 kWh and a long duration period between 5 and 40 hours. The short-term energy demand (electrical energy 233) by the electrical load 250 (for example, during car acceleration) is complimented by the EES 226, while short-term energy supply 231 from the electrical load 250 (for example, during car breaking) is absorbed by the EES 226. If the EES state of charge falls below a certain threshold (for example, 30%) and the CES 220 operates at maximum power output (for example, 200%), the power supply unit 206 can progressively curtail power output to the electrical load 250.

Additionally, the CES 220 provides a steady state power to the electrical load 250, while the EES 226 is designed to supplement and absorb high power capacity bidirectional fluctuations of load demand. The steady state power output of the CES 220 can be gradually adjusted (by power control unit 206) based on the state of charge of the EES 226. In an unlikely event that the CES 220 operates at a maximum power capacity and the EES state of charge falls below a certain limit, the overall power output to the electrical load 250 can be curtailed by the power control unit 206.

FIG. 3 is a schematic illustration of an example controller (or control system) 300 for a power supply system according to the present disclosure. For example, the controller 300 may include or be part of a control system 999 shown as part of power supply systems 100 or 200 according to the present disclosure. The controller 300 is intended to include various forms of digital computers, such as printed circuit boards (PCB), processors, digital circuitry, or otherwise parts of a power supply system. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 300 includes a processor 310, a memory 320, a storage device 330, and an input/output device 340. Each of the components 310, 320, 330, and 340 are interconnected using a system bus 350. The processor 310 is capable of processing instructions for execution within the controller 300. The processor may be designed using any of a number of architectures. For example, the processor 310 may be a CISC (Complex Instruction Set Computers) processor, a RISC (Reduced Instruction Set Computer) processor, or a MISC (Minimal Instruction Set Computer) processor.

In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the controller 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the controller 300. In one implementation, the storage device 330 is a computer-readable medium. In various different implementations, the storage device 330 may be a floppy disk device, a hard disk device, an optical disk device, or a tape device.

The input/output device 340 provides input/output operations for the controller 300. In one implementation, the input/output device 340 includes a keyboard and/or pointing device. In another implementation, the input/output device 340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A power supply system, comprising:
a chemical energy sub-system comprising at least one fuel cell and at least one fuel storage assembly, the at least one fuel cell configured to generate a first electrical energy output at a first power output from a fuel stored in the at least one fuel storage assembly;
an electrochemical energy sub-system comprising at least one energy storage device, the at least one energy storage device configured to generate a second electrical energy output at a second power output; and
a power control unit electrically coupled to the chemical energy sub-system and the electrochemical energy sub-system and configured to electrically couple the chemical energy sub-system and the electrochemical energy sub-system to an electrical load and provide at least one of the first electrical energy output or the second electrical energy output to the electrical load, the electrical load having a first power demand over a first time duration that is less than the first power output and a second power demand over a second time duration that is less than the second power output, the second time duration less than the first time duration.

2. The power supply system of claim 1, wherein the chemical energy sub-system comprises a thermal conductive medium thermally coupled between the at least one fuel cell and the fuel storage assembly.

3. The power supply system of claim 2, wherein the thermal conductive medium comprises a fluid heat transfer medium or a solid heat transfer medium.

4. The power supply system of claim 2, wherein the fuel storage assembly comprises a metal hydride, and the thermal conductive medium is thermally coupled between the at least one fuel cell and the metal hydride.

5. The power supply system of claim 4, wherein the fuel comprises uncompressed hydrogen, and the metal hydride is configured to exothermically adsorb at least a portion of the uncompressed hydrogen.

6. The power supply system of claim 4, wherein the metal hydride comprises iron titanium (FeTi) or magnesium (Mg).

7. The power supply system of claim 1, wherein the at least one energy storage device comprises a multi-gradient electrode.

8. The power supply system of claim 7, wherein the multi-gradient electrode comprises a multi-gradient graphite anode or a lithium metal anode.

9. The power supply system of claim 8, wherein the at least one energy storage device comprises a nano-crystallized Lithium cathode and a superconducting electrolyte.

10. The power supply system of claim 1, wherein the electrochemical energy sub-system is configured to electrically couple to the electrical load through the power control unit to provide the second electrical energy output to the electrical load and charge the at least one energy storage device with an electrical charging output from the electrical load through the power control unit.

11. The power supply system of claim 1, wherein each of the first power output energy storage capacity is between 100-200 kWh and second power output energy storage capacity is between 5-10 kWh.

12. The power supply system of claim 11, wherein the chemical energy sub-system is configured to provide a first power capacity of 5-20 kW over the first time duration, and the electrochemical energy sub-system is configured to have a second power capacity of 100-200 kW over the second time duration.

13. The power supply system of claim 12, wherein the first time duration is 5-40 hours, and the second time duration is 1.5-10 minutes.

14. The power supply system of claim 1, wherein the electrical load comprises a mobile electrical load.

15. The power supply system of claim 14, wherein the mobile electrical load comprises an electric vehicle for fuel cell vehicle.

16. The power supply system of claim 1, wherein the chemical energy subsystem includes an electrochemical device for hybrid electrical energy storage and hydrogen production.

17. A method of supplying power to an electrical load, comprising:
electrically coupling a power supply system to an electrical load, the power supply system comprising:
a chemical energy sub-system comprising at least one fuel cell and at least one fuel storage assembly that stores a fuel, the at least one fuel cell configured to generate a first electrical energy output at a first power output from the fuel;
an electrochemical energy sub-system comprising at least one energy storage device configured to generate a second electrical energy output at a second power output; and
a power control unit electrically coupled to the chemical energy sub-system and the electrochemical energy sub-system and electrically coupled to the electrical load; and
operating the power control unit to provide at least one of the first electrical energy output or the second electrical energy output to the electrical load, the electrical load having a first power demand over a first time duration that is less than the first power output and a second power demand over a second time duration that is less than the second power output, the second time duration less than the first time duration.

18. The method of claim 17, comprising transferring thermal energy between the at least one fuel cell and the fuel storage assembly with a thermal conductive medium.

19. The method of claim 18, wherein the thermal conductive medium comprises a fluid heat transfer medium or a solid heat transfer medium.

20. The method of claim 18, wherein transferring thermal energy comprises transferring thermal energy between a metal hydride of the fuel storage assembly and the at least one fuel cell with the thermal conductive medium.

21. The method of claim 20, wherein the fuel comprises uncompressed hydrogen, and the method comprises exothermically adsorb at least a portion of the uncompressed hydrogen into the metal hydride.

22. The method of claim 20, wherein the metal hydride comprises iron titanium (FeTi) or magnesium (Mg).

23. The method of claim 17, comprising storing the second electrical energy output in the at least one energy storage device with a multi-gradient electrode.

24. The method of claim 23, wherein the multi-gradient electrode comprises a multi-gradient graphite anode or a lithium metal anode.

25. The method of claim 24, wherein the at least one energy storage device comprises a nano-crystallized Lithium cathode and a superconducting electrolyte.

26. The method of claim 17, comprising charging the at least one energy storage device with an electrical charging output from the electrical load through the power control unit.

27. The method of claim 17, wherein each of the first power output energy storage capacity is between 100-200 kWh and second power output energy storage capacity is between 5-10 kWh.

28. The method of claim 27, wherein the chemical energy sub-system is configured to provide a first power capacity of 5-20 kW over the first time duration, and the electrochemical energy sub-system is configured to have a second power capacity of 100-200 kW over the second time duration.

29. The method of claim 28, wherein the first time duration is 5-40 hours, and the second time duration is 1.5-10 minutes.

30. The method of claim 17, wherein the electrical load comprises a mobile electrical load.

31. The method of claim 30, wherein the mobile electrical load comprises an electric vehicle for fuel cell vehicle.

32. The method of claim 17, wherein the chemical energy subsystem includes an electrochemical device for hybrid electrical energy storage and hydrogen production.
